(19) United States
(12) Patent Application Publication
(10) Pub. No.: US 2015/0022419 A1
(43) Pub. Date: Jan. 22, 2015

(54) ANTENNA DEVICE

(71) Applicant: CHIUN MAI COMMUNICATION SYSTEMS, INC., New Taipei (TW)

(72) Inventors: TZE-HSUAN CHANG, New Taipei (TW); CHO-KANG HSU, New Taipei (TW)

(73) Assignee: CHIUN MAI COMMUNICATION SYSTEMS, INC., New Taipei (TW)

(21) Appl. No.: 14/038,963

(22) Filed: Sep. 27, 2013

(30) Foreign Application Priority Data
Jul. 19, 2013 (TW) 102213679

(51) Int. Cl. H01Q 5/00

(52) U.S. Cl. CPC H01Q 5/0093
USPC 343/852

(57) ABSTRACT

An antenna device includes an antenna and a matching circuit. The antenna includes a first radiating body and a second radiating body. The matching circuit includes a first matching path connected to the first radiating body and a second matching path connected to the second radiating body. The first radiating body and the second radiating body correspondingly operate at a first frequency band and a second frequency band by adjusting impedances of the first matching path and the second matching path.

### BACKGROUND

1. Technical Field

The disclosure generally relates to antenna devices, and particularly to a dual band antenna device having a reduced size.

2. Description of Related Art

To communicate in multi-band communication systems, a bandwidth of an antenna of a wireless communication device such as a mobile phone should be wide enough to cover frequency bands of the multi-band communication systems. In addition, because of the miniaturization of the wireless communication device, available space for the antenna is reduced and limited. Therefore, it is necessary to design the antenna having the wider bandwidth within the reduced and limited space.

Therefore, there is room for improvement within the art.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the disclosure.

FIG. 1 is a schematic view of an antenna device, according to a first exemplary embodiment of the disclosure.

FIG. 2 is a circuit diagram of a matching circuit of the antenna device of FIG. 1, according to an exemplary embodiment of the disclosure.

FIG. 3 is a diagram showing return loss measurements of the antenna device of FIG. 1.

FIG. 4 is a diagram showing radiating efficiencies of the antenna device of FIG. 1.

FIG. 5A is a schematic view of an antenna of the antenna device of FIG. 1, according to a second exemplary embodiment of the disclosure.

FIG. 5B is a schematic view of an antenna of the antenna device of FIG. 1, according to a third exemplary embodiment of the disclosure.

FIG. 5C is a schematic view of an antenna of the antenna device of FIG. 1, according to a fourth exemplary embodiment of the disclosure.

### DETAILED DESCRIPTION

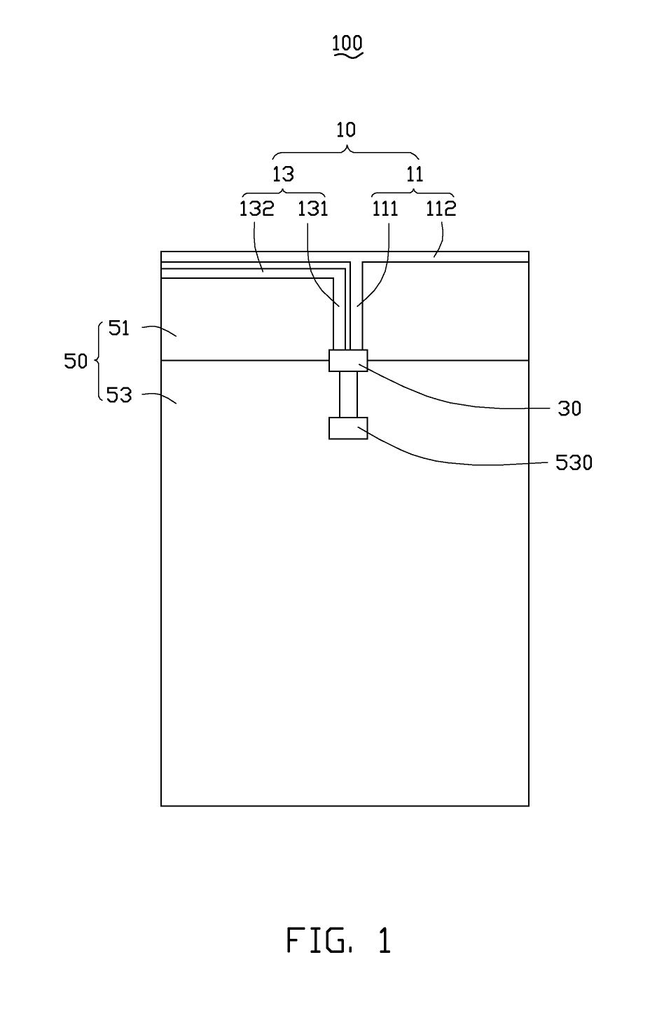

FIG. 1 is a schematic view of an antenna device 100, according to a first exemplary embodiment of the disclosure. The antenna device 100 includes an antenna 10, a matching circuit 30, and a print circuit board (PCB) 50.

The antenna 10 includes a first radiating body 11 operating at a first frequency band (e.g. a signal at frequency about 790 MHz-1190 MHz) and a second radiating body 13 operating at a second frequency band (e.g. a signal at frequency about 1672 MHz-2271 MHz). In this exemplary embodiment, the first radiating body 11 is substantially T-shaped and includes a first radiating section 111 and a second radiating section 112. The first radiating section 111 is connected to a middle area of the second radiating section 112. The second radiating body 13 is substantially L-shaped and includes a third radiating section 131 and a fourth radiating section 133 perpendicularly connected to the third radiating section 131. The third radiating section 131 is parallel to and spaced from the first radiating section 111. The fourth radiating section 133 is parallel to and spaced from a portion of the second radiating section 112. In this exemplary embodiment, a length and a width of the second radiating section 112 are about 68 mm and 1 mm. A length of the fourth radiating section 132 is about 20 mm. A distance between the fourth radiating section 132 and the second radiating section 112 is about 1 mm.

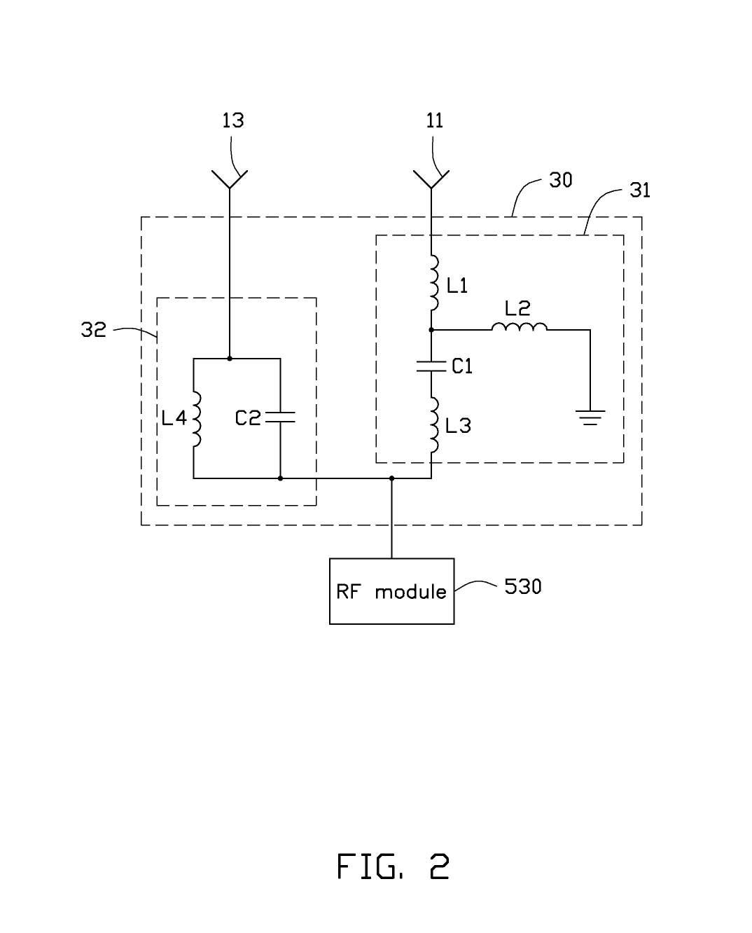

Also referring to FIG. 2, the matching circuit 30 includes a first matching path 31 and a second matching path 32.

One end of the first matching path 31 and one end of the second matching path 32 are both connected to an radio frequency (RF) module 530. Another end of the first matching path 31 is connected to the first radiating body 11. Another end of the second matching path 32 is connected to the second radiating body 13. The antenna 10 receives electronic signals transmitted from the RF module 530 by the matching circuit 30 and converts the electronic signals into radio waves and also transmits the radio waves received from other wireless communication devices to the RF module 530.

The first frequency band signal can be transmitted by the first matching path 31 so that the first radiating body 11 can transmit and receive the first frequency band signal. The second frequency band signal (e.g. a signal at frequency about 1672 MHz-2271 MHz) can be transmitted by the second matching path 32 so that the first radiating body 11 can transmit and receive the second frequency band signal. The antenna 10 is connected to the matching circuit 30 by an elastic member, a microchip, a coaxial cable and so on.

In this exemplary embodiment, the first matching path 31 includes a first inductor L1, a first capacitor C1, a second inductor L2, and a third inductor L3. The first inductor L1, the first capacitor C1, and the third inductor L2 are electronically connected in series between the first radiating body 11 and the RF module 530. One end of the second inductor L2 is electronically connected between the first capacitor C1 and the first inductor L1. Anther end of the second inductor L2 is grounded. In this exemplary embodiment, inductances of the first inductor L1, the second inductor L2, and the third inductor L3 are respectively 3.3 nH, 7.5 nH, and 15 nH. A capacitance of the first capacitor C1 may be from 0.5 pF to 2.0 pF, such as 1.3 pF.

The second radiating path 32 includes a fourth inductor L4 and a second capacitor C2 connected in parallel between the second radiating body 13 and the RF module 530. In this exemplary embodiment, an inductance of the fourth inductor L4 is about 12 nH, and a capacitance of the capacitor C2 is about 2.2 pF.

The PCB 50 includes an antenna mounting area 51 in which no conductive member (e.g. a speaker, a camera, etc.) is positioned and a ground plane 53. The first radiating body 11 and the second radiating body 13 are positioned on the mounting area 51. The RF module 530 is positioned at the ground plane 53. The matching circuit 30 is portioned on the PCB 50.

In use, to transmit and receive the first and second frequency band signals, the first frequency band signal is transmitted to the first radiating body 11 by adjusting the inductances of the first inductor L1, the second inductor L2, and the third inductor L3 so that the antenna device 100 can operate at LTE700/GSM850/GSM900 communication systems. The second frequency band signal is transmitted to the second radiating body 12 by adjusting the inductance of the fourth inductor L4 and the capacitance of the second capacitor C2 so that the antenna device 100 can operate at DCS/PCS/UMTS communication systems.

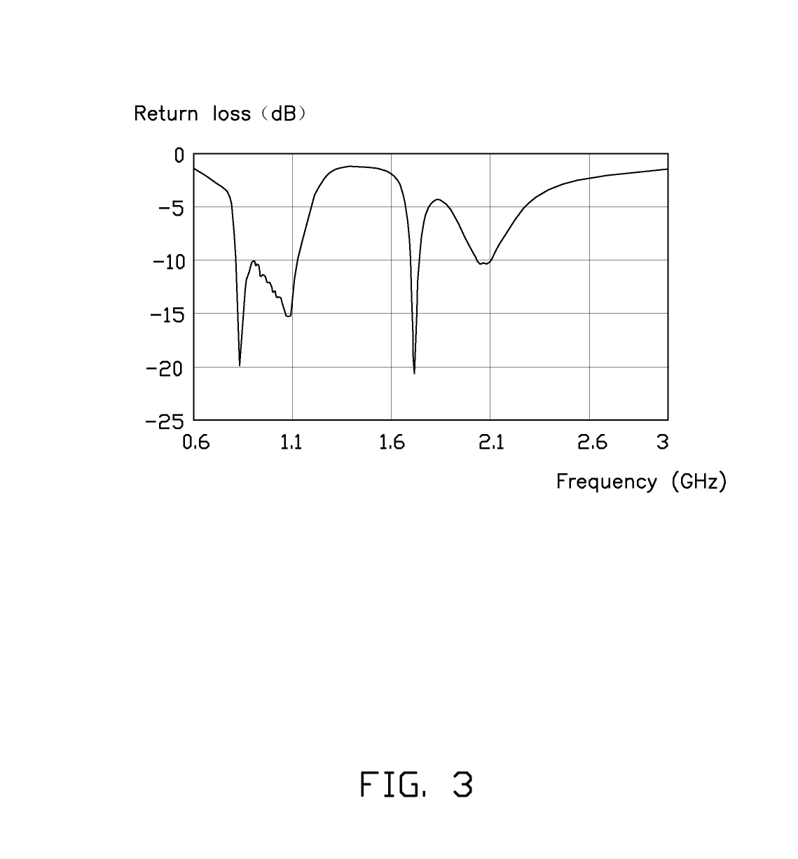

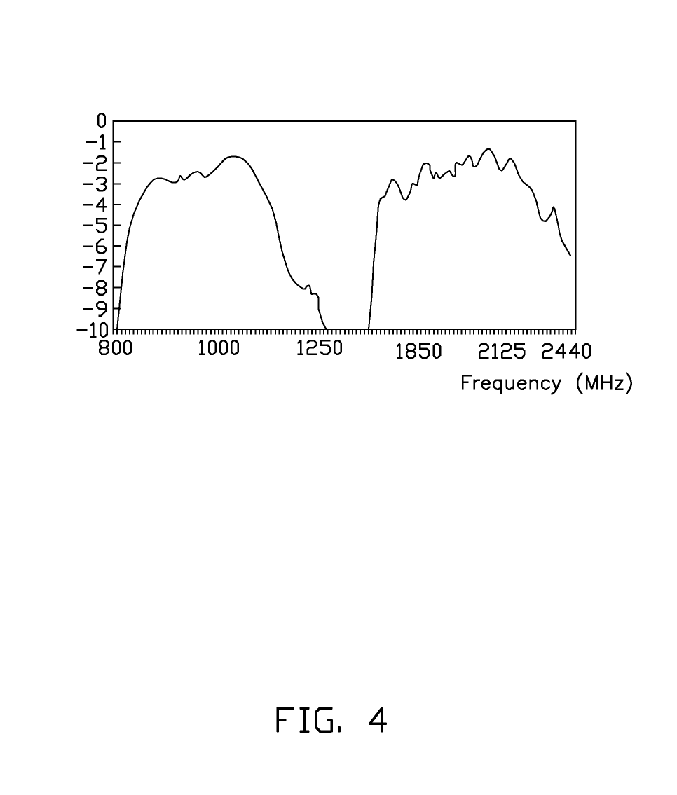

FIGS. 3 and 4 show that the antenna device 100 can satisfy design requirements at both the first frequency band (e.g. a signal at frequency about 790 MHz-1190 MHz) and the second frequency band (e.g. a signal at frequency about 1672 MHz-2271 MHz.

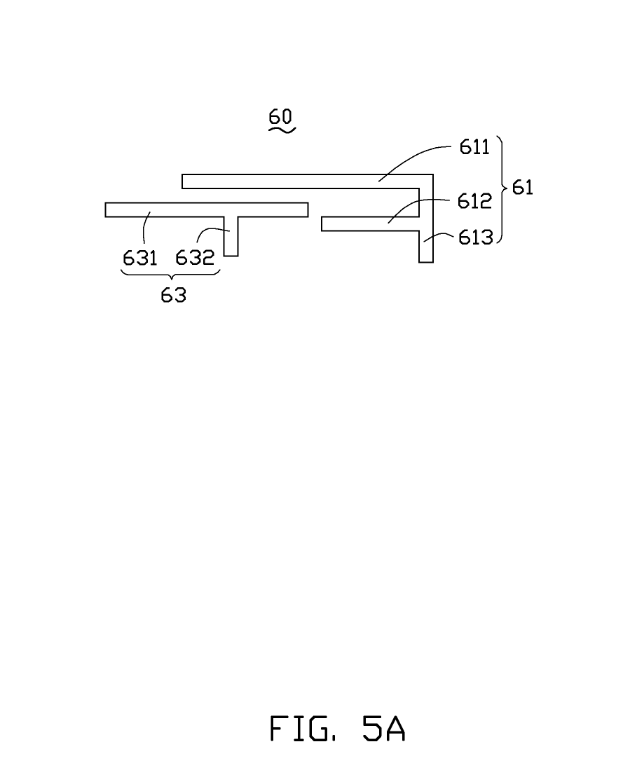

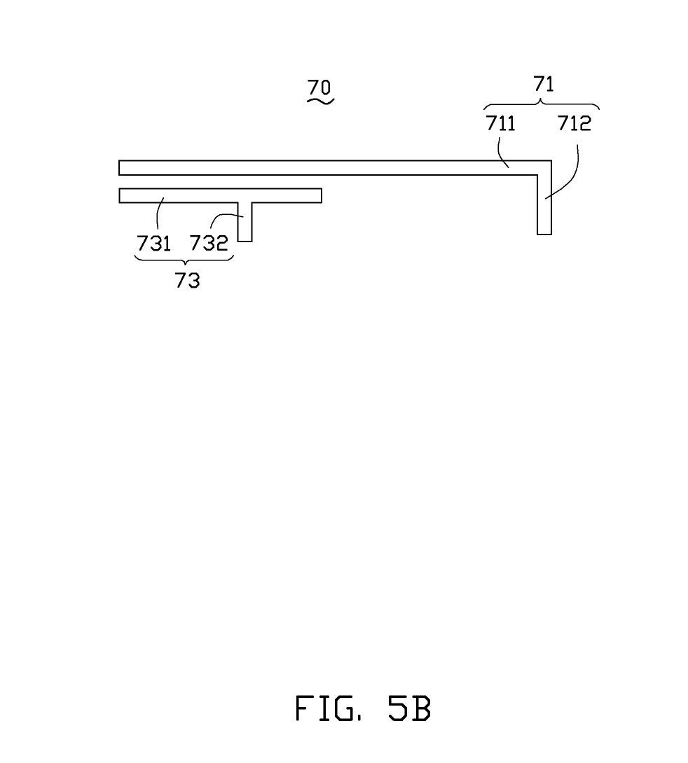

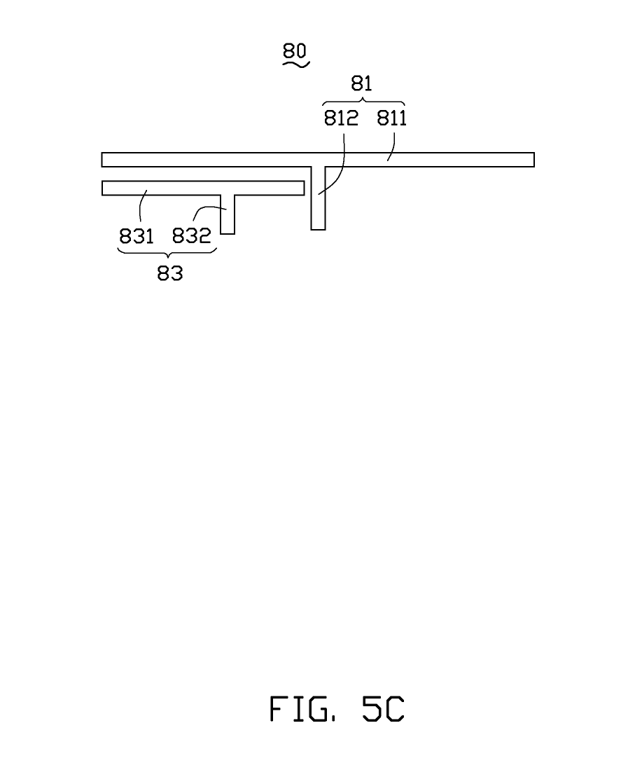

FIG. 5A shows an antenna 60 according to a second exemplary embodiment. The antenna 60 includes a first radiating body 61 and a second radiating body 63. The first radiating body 61 includes a first radiating section 611, a second radiating section 612, and a third radiating section 613. The second radiating section 612 is parallel to the first radiating section 611. A length of the second radiating section 612 is longer than that of the first radiating section 611. The third radiating section 613 is perpendicularly connected to the first radiating section 611 and the second radiating section 612. The second radiating body 63 is substantially T-shaped and includes a fourth radiating section 631 and a fifth radiating section 632 perpendicularly connected the fourth radiating section 631. The fourth radiating section 631 is parallel to and spaced from the first radiating section 611 and the second radiating section 612 and positioned between the first radiating section 611 and the second radiating section 612. The fifth radiating section 632 is parallel to the third radiating section 613.

FIG. 5B shows an antenna 70 according to a third exemplary embodiment. The antenna 70 includes a first radiating body 71 and a second radiating body 73. The first radiating body 71 is substantially L-shaped and includes a first radiating section 711 and a second radiating section 712 perpendicularly connected to an end of the first radiating section 711. The second radiating body 73 is substantially T-shaped and includes a third radiating section 731 and a fourth radiating section 732. The fourth radiating section 732 is perpendicularly connected to a middle portion of the fourth radiating section 731. The third radiating section 731 is parallel to and spaced from the first radiating section 711. The fourth radiating section 732 is parallel to and spaced from the second radiating section 712.

FIG. 5C shows an antenna 80 according to a third exemplary embodiment. The antenna 80 includes a first radiating body 81 and a second radiating body 83. The first radiating body 81 is substantially T-shaped and includes a first radiating section 811 and a second radiating section 812 perpendicularly connected to a middle portion of the first radiating section 811. The second radiating body 83 is substantially T-shaped and includes a third radiating section 831 and a fourth radiating section 832 perpendicularly connected to a middle portion of the third radiating section 831. The third radiating section 831 is parallel to and spaced from the first radiating section 811. The fourth radiating section 832 is parallel to and spaced from the second radiating section 812.

The antenna device 100 can both operates at the first frequency band and the second frequency band by adjusting impedances of the first matching path 31 and the second matching path 32 to correspondingly matching with the first radiating body 11 and the second radiating body 13. Therefore, the antenna device 100 can obtain a wider bandwidth with a simplified structure and a reduced size.

It is believed that the exemplary embodiments and their advantages will be understood from the foregoing description, and it will be apparent that various changes may be made thereto without departing from the spirit and scope of the disclosure or sacrificing all of its material advantages, the examples hereinbefore described merely being preferred or exemplary embodiments of the disclosure.

What is claimed is:

1. An antenna device, comprising:
an antenna comprising a first radiating body and a second radiating body; and
a matching circuit comprising a first matching path connected to the first radiating body and a second matching path connected to the second radiating body, the first radiating body and the second radiating body correspondingly operating at a first frequency band and a second frequency band by adjusting impedances of the first matching path and the second matching path.

2. The antenna device of claim 1, wherein the first matching path comprises a first inductor, a second inductor, a third inductor, and a first capacitor; the first inductor, the first capacitor and the third inductor are connected in series; the first inductor is connected to the first radiating body; one end of the second inductor is connected between the first inductor and the first capacitor; another end of the second inductor is grounded.

3. The antenna device of claim 2, wherein the second matching path comprises a fourth inductor and a second capacitor connected in parallel; one end of the fourth inductor and the second capacitor are connected to the second radiating body.

4. The antenna device of claim 1, wherein the first radiating body is substantially T- shaped and comprises a first radiating section and a second radiating section; the first radiating section is connected to a middle area of the second radiating section.

5. The antenna device of claim 4, wherein the second radiating body is substantially L-shaped and comprises a third radiating section and a fourth radiating section perpendicularly connected to the third radiating section; the third radiating section is parallel to and spaced from the first radiating section; the fourth radiating section is parallel to and spaced from a portion of the second radiating section.

6. The antenna device of claim 1, wherein the first radiating body comprises a first radiating section, a second radiating section, and a third radiating section; the second radiating section is parallel to the first radiating section; a length of the second radiating section is longer than that of the first radiating section; the third radiating section is perpendicularly connected to the first radiating section and the second radiating section.

7. The antenna device of claim 6, wherein the second radiating body is substantially T-shaped and includes a fourth radiating section and a fifth radiating section perpendicularly connected the fourth radiating section; the fourth radiating section is parallel to and spaced from the first radiating section and the second radiating section and positioned between the first radiating section and the second radiating section; the fifth radiating section is parallel to the third radiating section.

8. The antenna device of claim 1, wherein the first radiating body is substantially L-shaped and comprises a first radiating section and a second radiating section perpendicularly connected to an end of the first radiating section.

9. The antenna device of claim 8, wherein the second radiating body is substantially T-shaped and comprises a third radiating section and a fourth radiating section; the fourth radiating section is perpendicularly connected to a middle portion of the fourth radiating section; the third radiating section is parallel to and spaced from the first radiating section; the fourth radiating section is parallel to and spaced from the second radiating section.

10. The antenna device of claim 1, wherein the first radiating body is substantially T-shaped and comprises a first radiating section and a second radiating section perpendicularly connected to a middle portion of the first radiating section.

11. The antenna device of claim 10, wherein the second radiating body is substantially T-shaped and comprises a third radiating section and a fourth radiating section perpendicularly connected to a middle portion of the third radiating section; the third radiating section is parallel to and spaced from the first radiating section; the fourth radiating section is parallel to and spaced from the second radiating section.

12. An antenna device, comprising:
an antenna comprising a first radiating body and a second radiating body; and
a matching circuit comprising a first matching path configured to transmit a first frequency band signal and a second matching path configured to transmit a second frequency band signal, the first matching path connected to the first radiating body, the second matching path connected to the second radiating body.

13. The antenna device of claim 12, wherein the first matching path comprises a first inductor, a second inductor, a third inductor, and a first capacitor; the first inductor, the first capacitor and the third inductor are connected in series; the first inductor is connected to the first radiating body; one end of the second inductor is connected between the first inductor and the first capacitor; another end of the second inductor is grounded.

14. The antenna device of claim 13, wherein the second matching path comprises a fourth inductor and a second capacitor connected in parallel; one end of the fourth inductor and the second capacitor are connected to the second radiating body.

15. The antenna device of claim 12, wherein the first radiating body is substantially T-shaped and comprises a first radiating section and a second radiating section; the first radiating section is connected to a middle area of the second radiating section.

16. The antenna device of claim 15, wherein the second radiating body is substantially L-shaped and comprises a third radiating section and a fourth radiating section perpendicularly connected to the third radiating section; the third radiating section is parallel to and spaced from the first radiating section; the fourth radiating section is parallel to and spaced from a portion of the second radiating section.

17. The antenna device of claim 12, wherein the first radiating body comprises a first radiating section, a second radiating section, and a third radiating section; the second radiating section is parallel to the first radiating section; a length of the second radiating section is longer than that of the first radiating section; the third radiating section is perpendicularly connected to the first radiating section and the second radiating section.

18. The antenna device of claim 17, wherein the second radiating body is substantially T-shaped and includes a fourth radiating section and a fifth radiating section perpendicularly connected the fourth radiating section; the fourth radiating section is parallel to and spaced from the first radiating section and the second radiating section and positioned between the first radiating section and the second radiating section; the fifth radiating section is parallel to the third radiating section.

19. The antenna device of claim 12, wherein the first radiating body is substantially L-shaped and comprises a first radiating section and a second radiating section perpendicularly connected to an end of the first radiating section.

20. The antenna device of claim 19, wherein the second radiating body is substantially T-shaped and comprises a third radiating section and a fourth radiating section; the fourth radiating section is perpendicularly connected to a middle portion of the fourth radiating section; the third radiating section is parallel to and spaced from the first radiating section; the fourth radiating section is parallel to and spaced from the second radiating section.
